(19) United States
(12) Patent Application Publication
(10) Pub. No.: US 2012/0253699 A1
(43) Pub. Date: Oct. 4, 2012

(54) INPUT APPARATUS AND CONTACT STATE DETECTION METHOD

(75) Inventor: Toshiya Kuno, Hamura-shi (JP)

(73) Assignee: CASIO COMPUTER CO., LTD., Tokyo (JP)

(21) Appl. No.: 13/432,829

(22) Filed: Mar. 28, 2012

(30) Foreign Application Priority Data
Mar. 29, 2011 (JP) 2011-071982

(51) Int. Cl. G06F 19/00; G01L 1/00

(52) U.S. Cl. 702/41; 73/862.381

(57) ABSTRACT

An input apparatus includes a contact device that includes a shaft member, a first sensor configured to detect, when a tip of the shaft member comes into contact with a surface of a contacted object, a first force corresponding to a component of a force applied to the tip, which acts in a planar direction crossing a direction of an axis of the shaft at right angles, and a second sensor configured to detect a second force corresponding to a component of the applied force, which acts in a direction of the axis of the shaft member.

### CROSS-REFERENCE TO RELATED APPLICATIONS

This application is based upon and claims the benefit of priority under 35 USC 119 of Japanese Patent Application No. 2011-071982 filed Mar. 29, 2011, the entire disclosure of which, including the description, claims, drawings, and abstract, is incorporated herein by reference in its entirety.

### BACKGROUND OF THE INVENTION

1. Field of the Invention

The present invention relates to an input apparatus and a contact state detection method.

2. Description of the Related Art

For example, as described in Jpn. Pat. Appln. KOKAI Publication No. 11-39087, an input apparatus is conventionally known in which, for example, a contact device of a stylus is slid on a surface of a contacted object such as a touch panel or paper to allow a trajectory of the contact device to be output to a display device. A stylus is known which incorporates an omnidirectional pressure sensitive sensor at a tip of a pen so as to detect a direction of resistance such as a frictional force which is applied directly to the pen tip by the contacted object during writing, based on a variation in pressure detected by the pressure sensitive sensor.

In the above-described stylus, the intensity of resistance such as a frictional force varies depending on the materials of the pen tip and the contacted object. It has thus been difficult to accurately detect a component of a writing pressure applied to the contacted object by the pen tip, which acts in a normal direction of the surface of the contacted object.

### BRIEF SUMMARY OF THE INVENTION

According to one aspect of the present invention, there is provided an input apparatus comprising: a contact device that includes: a shaft member; a first sensor configured to detect, when a tip of the shaft member comes into contact with a surface of a contacted object, a first force corresponding to a component of a force applied to the tip, which acts in a planar direction crossing a direction of an axis of the shaft at right angles; and a second sensor configured to detect a second force corresponding to a component of the applied force, which acts in a direction of the axis of the shaft member.

According to another aspect of the present invention, there is provided a contact state detection method comprising: detecting, when a tip of the shaft member comes into contact with a surface of a contacted object, a first force corresponding to a component of a force applied to the tip, which acts in a planar direction crossing a direction of an axis of the shaft at right angles; and calculating an angle of rotation by which the shaft member rotates around the axis of the shaft member, based on a result of the detection.

According to still another aspect of the present invention, there is provided a contact state detection method comprising: detecting, when a tip of the shaft member comes into contact with a surface of a contacted object, a first force corresponding to a component of a force applied to the tip, which acts in a planar direction crossing a direction of an axis of the shaft at right angles, and detecting a second force corresponding to a component of the applied force, which acts in a direction of the axis of the shaft member; and calculating a magnitude of the force applied to the surface of the contacted object by the tip of the shaft member, based on results of the detections.

According to still another aspect of the present invention, there is provided a contact state detection method comprising: detecting, when a tip of the shaft member comes into contact with a surface of a contacted object, a first force corresponding to a component of a force applied to the tip, which acts in a planar direction crossing a direction of an axis of the shaft at right angles, and detecting a second force corresponding to a component of the applied force, which acts in a direction of the axis of the shaft member; and calculating an angle between the shaft member and a plane passing through a contact point between the shaft member and the surface of the contacted object and contacting the surface of the contacted object, based on results of the detections.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically illustrating a configuration of an input apparatus according to the present embodiment;

FIG. 2 is a perspective view showing a general configuration of a contact device provided in the input apparatus in FIG. 1;

FIG. 3 is a perspective view showing an internal configuration of a tip of the contact device in FIG. 2;

FIG. 4 is a cross-sectional view of a first sensor provided in the contact device in FIG. 2, the view being taken along a line of cutting plane IV-IV in FIG. 3;

FIG. 5 is a block diagram showing a main control configuration of the input apparatus according to the present embodiment;

FIG. 6 is a diagram illustrating components of a force applied to a contacted object by the contact device in FIG. 2;

FIG. 7 is a schematic diagram illustrating a method of determining a rotating torque based on a force detected by the first sensor;

FIG. 8 is a schematic diagram illustrating a method of determining an angle of rotation by which a shaft member rotates around the axis of the shaft member;

FIG. 9 is a flowchart of processing carried out by the contact device in FIG. 2;

FIG. 10 is a perspective view showing an example of an operative state of the contact device in FIG. 2;

FIG. 11 is a perspective view showing an example of the operative state of the contact device in FIG. 2;

FIG. 12 is a flowchart of processing carried out by a control device in FIG. 5;

FIG. 13 is a perspective view showing an example in which a drawing line with no drawing effect applied thereto is displayed on the display device;

FIG. 14 is a perspective view showing an example in which a drawing line with a line width changing effect, one of the drawing effects, applied thereto is displayed on the display device; and

FIG. 15 is a perspective view showing an example in which a drawing line with a line type changing effect, one of the drawing effects, applied thereto is displayed on the display device.

### DETAILED DESCRIPTION OF THE INVENTION

Embodiments of the present invention will be explained with reference to the drawings. However, the embodiments described below involves various technically preferable limitations for implementing the present invention, the scope of the present invention is not limited to the embodiments and illustrated examples described below.

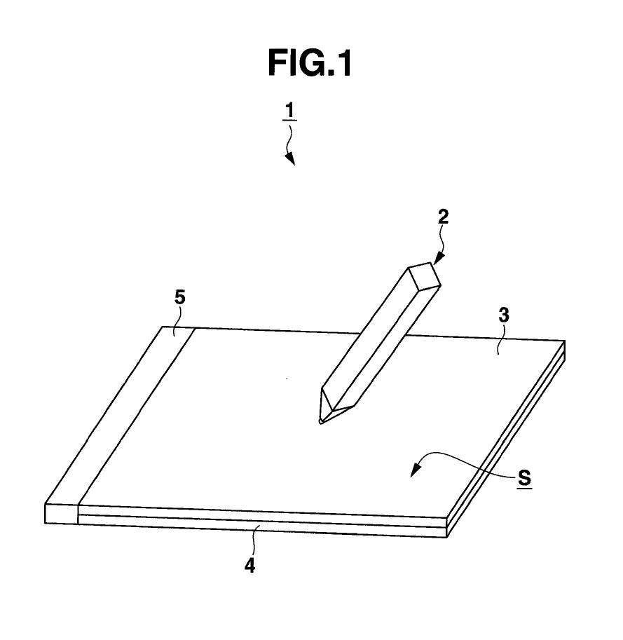

FIG. 1 is a diagram illustrating a general configuration of an input apparatus according to the present embodiment. As shown in FIG. 1, an input apparatus 1 includes a contact device 2, a contacted device 3, a display device 4, and a control device 5.

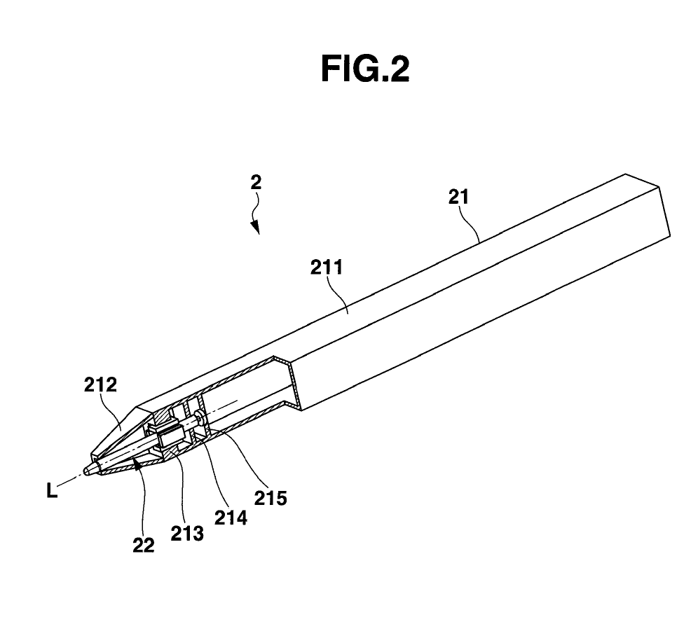

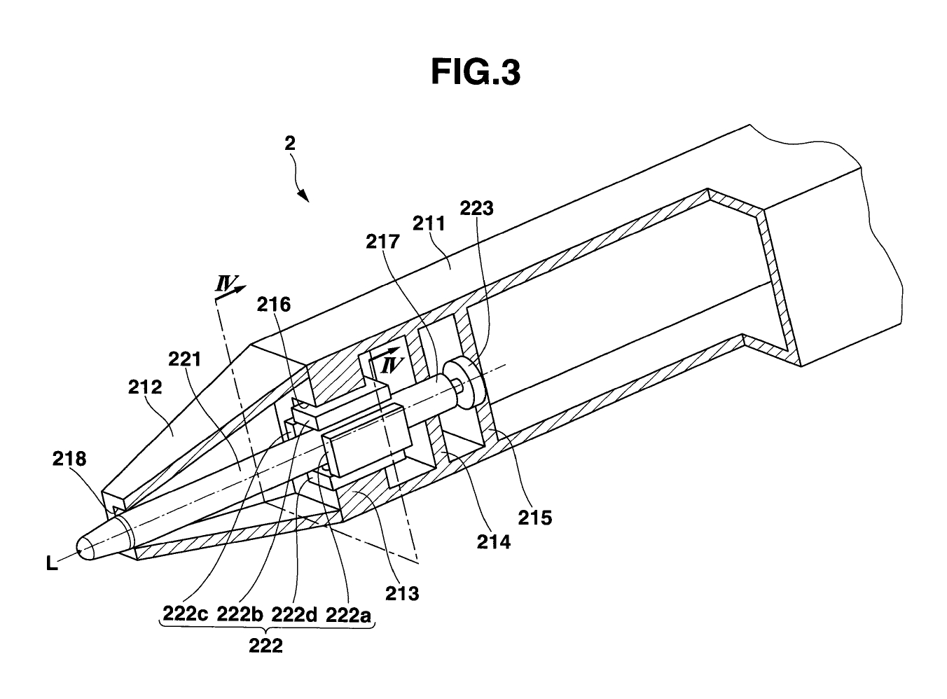

The contact device 2 is, for example, a stylus, and has a wired or wireless connection to the control device 5 for communication with the control device 5. FIG. 2 is a perspective view showing a general configuration of the contact device 2, with an internal structure shown only for a tip of the contact device 2. As shown in FIG. 2 and FIG. 3, the contact device 2 includes a pen-shaped main body 21, and a pen tip 22 provided at a tip of the main body 21.

The main body 21 includes a grip portion 211 formed like a square pillar and gripped by a user and a tip 212 formed substantially like a quadrangular pyramid so as to taper from a tip of the grip portion 211. The grip portion 211 is internally hollow so as to include various built-in circuit components (not shown in the drawings). Furthermore, the grip portion 211 includes three partition walls 213, 214, 215 formed at the tip thereof and spaced at predetermined intervals. Of the three partition walls 213, 214, and 215, the tip-side partition wall 213 and the intermediate partition wall 214 include holes 216 and 217, respectively, formed therein to hold the pen tip 22. The hole 216 in the tip-side partition wall 213 is formed like a square pillar. Each of the inner surfaces of the hole 216 is parallel to a corresponding one of the outer side surfaces of the grip portion 211. The hole 217 in the intermediate partition wall 214 is formed like a cylinder.

On the other hand, an opening 218 through which the pen tip 22 is allowed to project is formed at a tip portion of the tip 212.

The pen tip 22 includes a shaft member 221, a first sensor 222, and a second sensor 223.

The shaft member 221 is substantially cylindrical, and a tip of the shaft member 221 is formed into a curved surface projecting further from the tip. The shaft member 221 is arranged inside the holes 216 and 217 so as to extend from the partition wall 215, located most inward, to the opening 218. The shaft member 221 is not limited to the substantially cylindrical shape but may be shaped to extend generally along the linear axis.

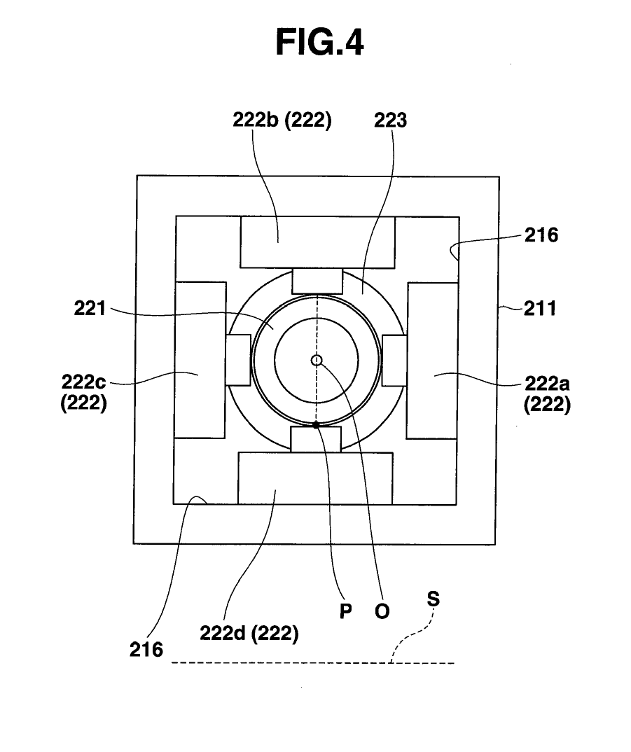

FIG. 4 is a cross-sectional view of the first sensor taken along a line of cutting plane IV-IV in FIG. 3. As shown in FIG. 3 and FIG. 4, the first sensor 222 includes four first sensors 222a, 222b, 222c, and 222d corresponding to the respective outer side surfaces of the grip portion 211. The first sensors 222a, 222b, 222c, and 222d are planar-direction sensors configured to detect rotating torques acting on the shaft member 221. The four first sensors 222a, 222b, 222c, and 222d are arranged at positions relative to the axis L of the shaft member 221 which are displaced by 90°, 180°, and 270° from one another as seen along the axis L of the shaft member 221. Surfaces of the first sensors 222a, 222b, 222c, and 222d located opposite the shaft member 221 are arranged to contact four different areas of the side surface of the shaft member 221. These surfaces of the first sensors 222a, 222b, 222c, and 222d form pressure sensitive sections thereof. Thus, the first sensors 222a, 222b, 222c, and 222d can detect a component of a force applied to the tip of the shaft member 221, which acts in a planar direction orthogonal to the direction of the axis L of the shaft member 221.

The second sensor 223 includes an axial-direction sensor configured to detect a component of a force applied to the shaft member 221, which acts in the direction of the axis L of the shaft member 221. The second sensor 223 is arranged to contact a proximal end of the shaft member 221 between the proximal end of the shaft member 221 and the partition wall 215, located most inward. Thus, the second sensor 223 can detect the component of the force applied to the shaft member 221, which acts in the direction of the axis L of the shaft member 221.

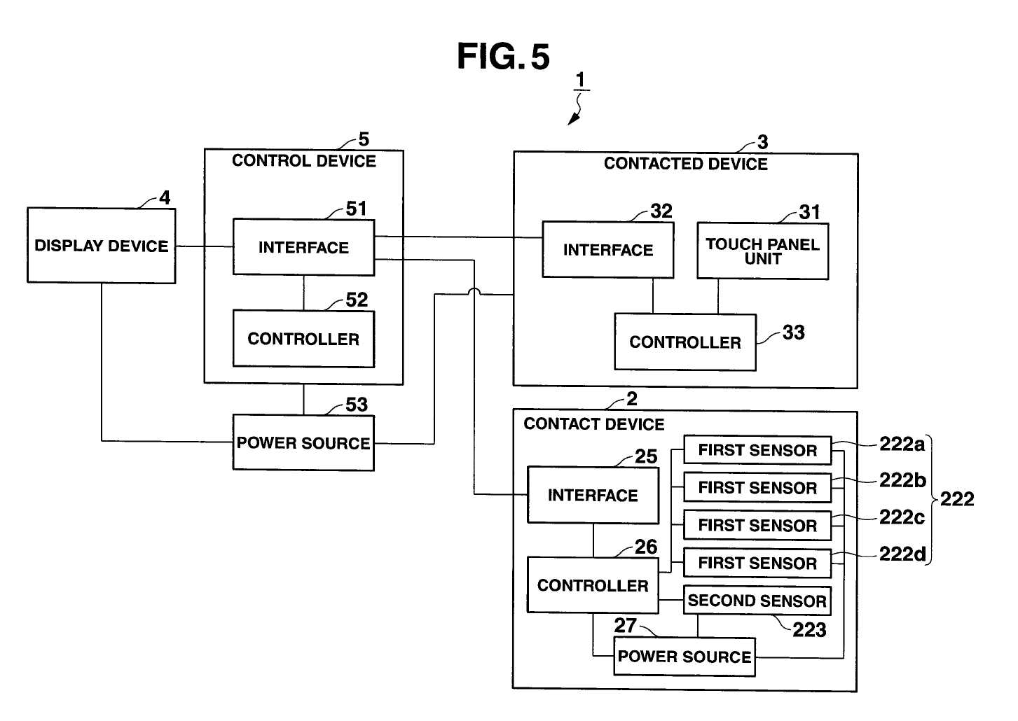

FIG. 5 is a block diagram showing a main control configuration of the input apparatus according to the present embodiment. As shown in FIG. 5, the contact device 2 includes interface 25 serving as an information transmission unit, a controller 26, a first sensor 222, a second sensor 223, and a power source 27. The controller 26 connects electrically to the first sensor 222, the second sensor 223, the power source 27, and interface 25. As described above, the first sensor 222 includes the four first sensors 222a, 222b, 222c, and 222d, which are individually connected to the controller 26. The controller 26 calculates various values based on a first detection result from each of the first sensors 222a, 222b, 222c, and 222d and a second detection result from the second sensor 223. The controller 26 then transmits first information including the result of the calculation to an exterior by interface 25. Furthermore, the control device 5 includes interface 51 serving as an information reception unit and a controller 52 configured to control interface 51. The contacted device 3 includes interface 32 serving as an information transmission unit, a touch panel unit 31 serving as a contacted object and including an input surface accepting contact and configured to transmit a signal corresponding to a contact position on the input surface where the contact device contacts the input surface, and a controller 33 configured to control interface 32 and the touch panel unit 31. Moreover, the input apparatus 1 includes a power source 53 configured to supply power to the contacted device 3, the display device 4, and the control device 5.

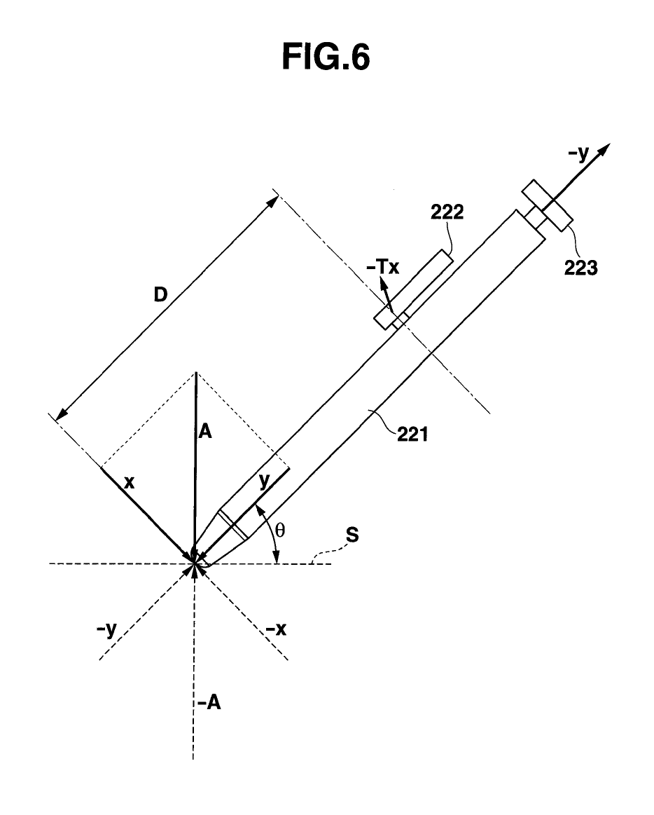

FIG. 6 is a diagram illustrating components of a force applied to the contacted object by the contact device 2. With reference to FIG. 6, first, a contact state detection method, in which the contact state is detected in the case where only one of the four first sensors 222a, 222b, 222c, and 222d, for example, only the first sensor 222a detects a force, whereas the other first sensors 222b, 222c, and 222d do not detect any force, will be described. As shown in FIG. 6, the following definitions are given if a force A is applied to the tip 212 of the shaft member 221 when the tip 212 of the shaft member 221 is brought into contact with a surface of the touch panel unit 31: a force x is defined as a component of force A which acts in the planar direction crossing the direction of the axis L of the shaft member 221 at right angles, and a force y is defined as a component of force A which acts in the direction of the axis L of the shaft member 221. A reaction force (−y) to force y is detected by the second sensor 223 as a second force corresponding to force y. On the other hand, a rotating torque (−Tx) obtained by integrating the reaction force (−x) to force x over a distance D from the tip of the shaft member 221 to the first sensor 222a is detected by the first sensor 222a as a first force corresponding to force x. That is, force x is determined by Expression (1), and force A is determined by Expression (2). Furthermore, the following are determined by Expression (3): a plane S passing through the contact point between the surface of the contacted object and the shaft member 221 and contacting the surface of the contacted object, and the angle θ between the shaft member 221 and the axis L.

x=Tx/D (1)

A=√(x²+y²) (2)

θ=cos⁻¹(x/A) (3)

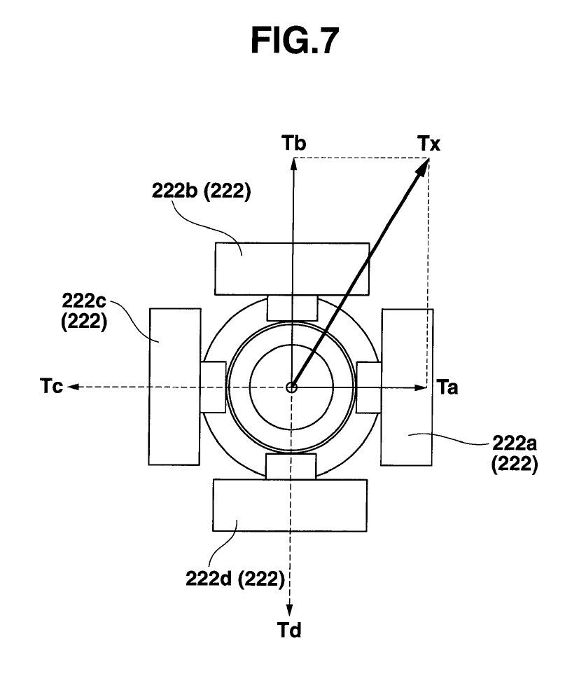

Now, with reference to FIG. 7, a contact state detection method, in which the contact state is detected in the case where a plurality of first sensors 222 detect forces, will be described. FIG. 7 is a schematic diagram illustrating a method of determining a rotating torque (−Tx) based on forces detected by the two first sensors 222a and 222b. FIG. 7 shows a cross section of the four first sensors 222a, 222b, 222c, and 222d and the shaft member 221 taken along a plane crossing the axis L of the shaft member 221 at right angles and passing through the four first sensors 222a, 222b, 222c, and 222d. The pen tip 22 according to the present embodiment includes the four first sensors 222a, 222b, 222c, and 222d arranged at positions relative to the axis L of the shaft member 221 which are displaced by 90°, 180°, and 270° from one another. When the four first sensors 222a, 222b, 222c, and 222d are arranged in this manner, three or more adjacent first sensors are prevented from detecting forces. With this taken into account, when the magnitudes of forces detected by the four first sensors 222a, 222b, 222c, and 222d are denoted by Ta, Tb, Tc, and Td, the rotating torque (−Tx) is expressed by:

Tx=√(Ta²+Tb²+Tc²+Td²) (4)

Force x is determined by substituting the rotating torque (−Tx) determined by Expression (4) into Expression (1) described above. Force A and the angle θ are determined by substituting force x obtained in this case and the above-described force y and into Expressions (2) and (3).

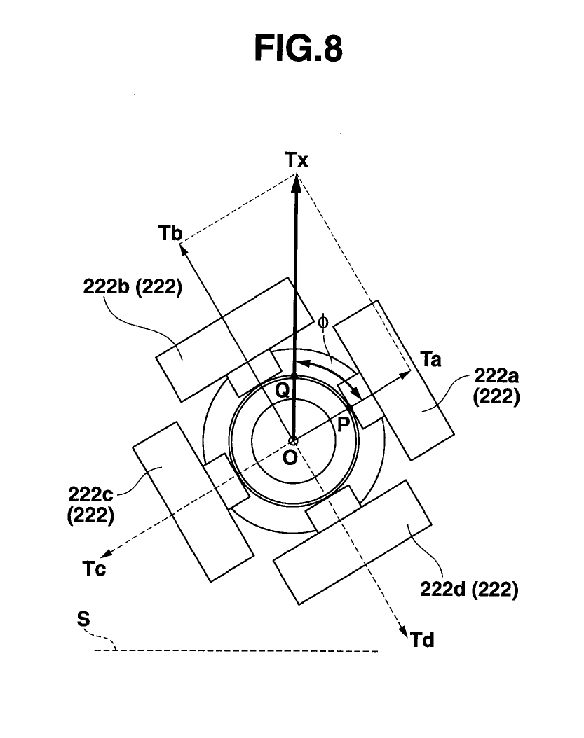

FIG. 8 is a schematic diagram illustrating a method of determining an angle of rotation φ by which the shaft member 221 rotates around the axis L of the shaft member 221. FIG. 8 shows a cross section of the four first sensors 222a, 222b, 222c, and 222d and the shaft member 221 taken along a plane crossing the axis L of the shaft member 221 at right angles and passing through the four first sensors 222a, 222b, 222c, and 222d. Here, the angle of rotation φ is the angle by which the shaft member 221 rotates around the axis L of the shaft member 221. Specifically, when a point O is defined as the intersection point between the axis L of the shaft member 221 and a plane crossing the axis L of the shaft member 221 at right angles, and a point P is defined as a specific point on the periphery of a cross-sectional shape of the shaft member 221 taken along a plane passing through the point O and crossing the axis L at right angles, the angle of rotation φ is defined as the magnitude of the angle between a segment OP and a half line having the point O as a starting point and extending in the direction of a rotating torque exerted on the shaft member 221 when the tip 212 of the shaft member 221 comes into contact with the surface of the contacted object. In FIG. 8, the intersection point between the above-described half line and the periphery of the cross-sectional shape is denoted as a point Q. As described above, three or more adjacent first sensors are prevented from detecting forces. When the two first sensors 222a and 222b detect the forces of the rotating torques Ta and Tb, the angle of rotation φ is expressed by:

φ=tan⁻¹(Tb/Ta) (5)

When the two adjacent first sensors arranged counterclockwise adjacent to each other as seen from the tip of the axis L detect components of the rotating torque, the components detected by the respective first sensors are denoted by Ta and TB in order in the counterclockwise direction. Furthermore, when the two first sensors 222a and 222b detect components of the rotating torque, a value determined by Expression (5) shown below is used directly as the angle of rotation φ. When the two first sensors 222b and 222c detect components of the rotating torque, the angle of rotation φ is determined by adding 90° to the value determined by Expression (5). Similarly, when the two first sensors 222c and 222d detect components of the rotating torque, the angle of rotation φ is determined by adding 180° to the value determined by Expression (5). When the two first sensors 222d and 222a detect components of the rotating torque, the angle of rotation φ is determined by adding 270° to the value determined by Expression (5).

As described above, based on the first detection result and the second detection result, the controller 26 calculates the magnitude of the force (force A) applied to the contacted object by the shaft member 221 and the angle θ between the shaft member 221 and a plane S related to the contacted object and passing through the contact point between the surface of the contacted object and the shaft member 221. At this time, the controller 26 serves as a second calculation unit and a third calculation unit. Furthermore, the controller 26 calculates the angle of rotation φ of the shaft member 221 based on the first detection result. At this time, the controller 26 serves as a first calculation unit.

Upon obtaining the results of the calculations, the controller 26 transmits the calculation results from interface 25 to the control device 5. At this time, the controller 26 and interface 25 serve as an information transmission unit.

The touch panel unit 31 is the contacted object with the surface thereof contacted by the tip of the shaft member 221. When the tip of the shaft member 221 comes into contact with the touch panel unit 31, the touch panel unit 31 outputs an electric signal corresponding to the contact position, to the controller 33. Based on the electric signal from the touch panel unit 31, the controller 33 detects the contact position where the tip of the shaft member 221 contacts the surface of the contacted object. The controller 33 then transmits second information containing the electric signal corresponding to the contact position, to the exterior by interface 32.

The display device 4 is, for example, a monitor and is electrically connected to interface 51 of the control device 5. The display device 4 provides display under the control of the control device 5. The display device 4 is arranged on the back side of the contacted device 3 as shown in FIG. 1 so that display contents are displayed through the contacted device 3.

As shown in FIG. 5, the control device 5 includes interface 51 and the controller 52, which are electrically connected together. The controller 52 calculates the contact position based on the second information transmitted by the contacted device 3. The controller 52 then controls the display device 4 so that, for example, a drawing line is displayed at the position corresponding to the contact position. At this time, the controller 52 reads force A, the angle of rotation φ, and the angle θ from the first information transmitted by the contact device 2. For each result of the reading, the controller 52 applies a different drawing effect to the drawing line. At this time, the controller 52 serves as a drawing effect applying unit.

The drawing effects include, for example, a line width changing effect of changing the thickness of a drawing line, a line color changing effect of changing the color of a drawing line, a line type changing effect of changing the type of a drawing line, and an erasing effect of erasing a temporarily drawn drawing line. Specifically, force A and the line width changing effect are associated with each other so that the thickness of the drawing line increases consistently with the magnitude of force A. Furthermore, the angle θ, the line width changing effect, the line color changing effect are associated with one another so that as the angle θ is closer to 90°, the drawing line becomes thinner and darker in color, whereas as the angle θ deviates further from 90°, the drawing line gradually becomes thicker and lighter in color.

Furthermore, the angle of rotation φ and the line type changing effect are associated with each other. One of the four side surfaces of contact device 2 which is located most upward can be detected based on the angle of rotation φ. Thus, if different line types are associated with the respective side surfaces, the angle of rotation φ corresponds to the line type associated with the side surface located most upward. For example, of the four side surfaces, a first side surface is assigned a “solid line”, a second side surface is assigned a “dashed line”, a third side surface is assigned an “alternate long and short dash line”, and a fourth side surface is assigned “erase”.

Now, operation of the present embodiment will be described below.

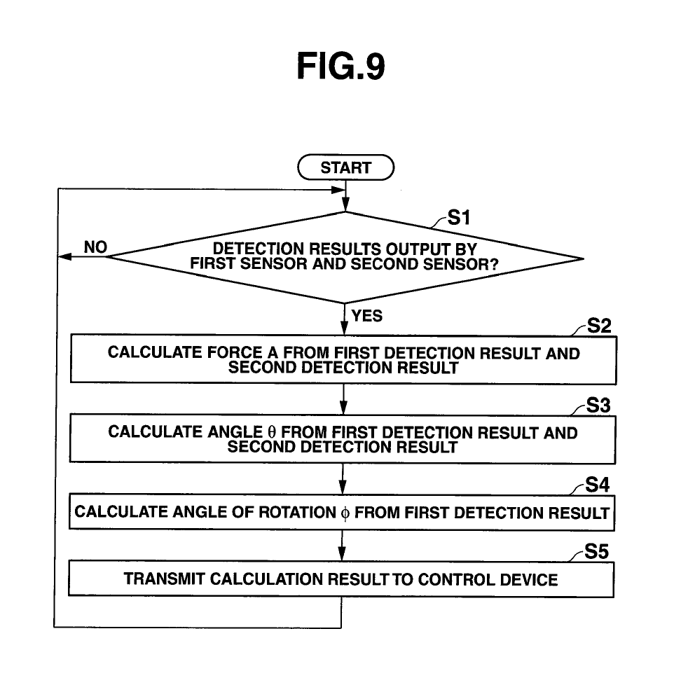

First, operation of the contact device 2 will be described. FIG. 9 is a flowchart of processing carried out by the contact device 2. As shown in FIG. 9, the controller 26 of the contact device 2 detects outputs from the first sensor 222 and the second sensor 223 (step S1). If the output from one of the first sensor 222 and the second sensor 223 is not zero, the controller 26 shifts to step 2. If all the outputs from the first sensor 222 and the second sensor 223 are zero, the controller 26 remains in a wait state.

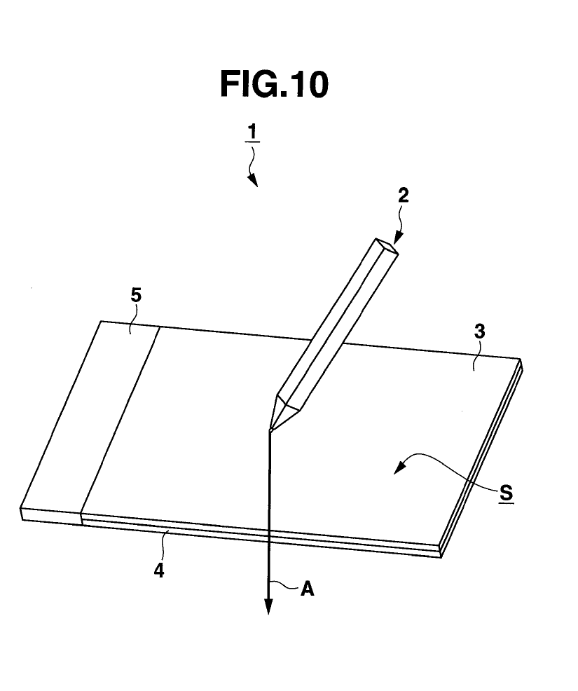

In step S2, the controller 26 of the contact device 2 calculates force A, shown in FIG. 10, based on the first detection result from each of the four first sensors 222 and the second detection result from the second sensor 223.

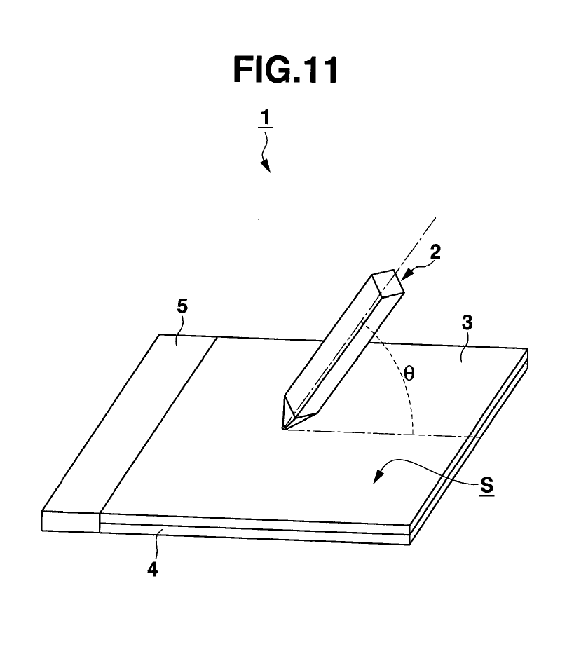

In step S3, the controller 26 of the contact device 2 calculates the angle θ, shown in FIG. 11, based on the first detection result from each of the four first sensors 222 and the second detection result from the second sensor 223.

In step S4, the controller 26 of the contact device 2 calculates the angle of rotation φ based on the first detection result from each of the four first sensors 222.

In step S5, the controller 26 of the contact device 2 transmits first information including the results of the calculations from interface 25 to the control device 5.

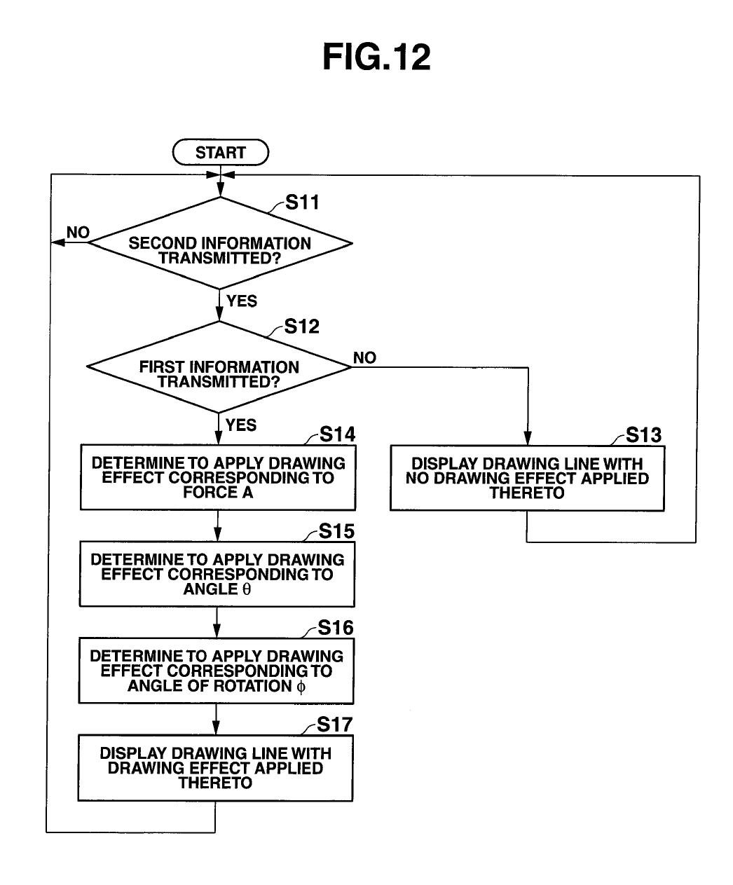

Now, operation of the control device 5 will be described. FIG. 12 is a flowchart of processing carried out by the control device 5. As shown in FIG. 12, the controller 52 of the control device 5 determines whether or not second information has been transmitted by the contacted device 3 (step S11). If the second information has been transmitted by the contacted device 3, the controller 52 shifts to step 12. If the second information has not been transmitted by the contacted device 3, the controller 26 remains in the wait state.

In step S12, the controller 52 of the control device 5 determines whether or not first information has been transmitted by the contact device 2. If the first information has been transmitted by the contact device 2, the controller 52 shifts to step 14. If the second information has not been transmitted by the contact device 2, the controller 26 shifts to step S13.

In step S13, the controller 52 of the control device 5 calculates the contact position based on the second information. The controller 52 then controls the display device 4 so that a drawing line with no drawing effect applied thereto is displayed on a display surface of the display device 4 at a position corresponding to the contact position.

In step S14, the controller 52 of the control device 5 reads force A from the first information, and determines to apply the drawing effect corresponding to force A.

In step S15, the controller 52 of the control device 5 reads the angle θ from the first information, and determines to apply the drawing effect corresponding to the angle θ.

In step S16, the controller 52 of the control device 5 reads the angle of rotation φ from the first information, and determines to apply the drawing effect corresponding to the angle of rotation φ.

In step S17, the controller 52 of the control device 5 calculates the contact position based on the second information. The controller 52 then controls the display device 4 so that a drawing line to which the drawing effect determined as described above has been applied is displayed on the display surface of the display device 4 at the position corresponding to the contact position.

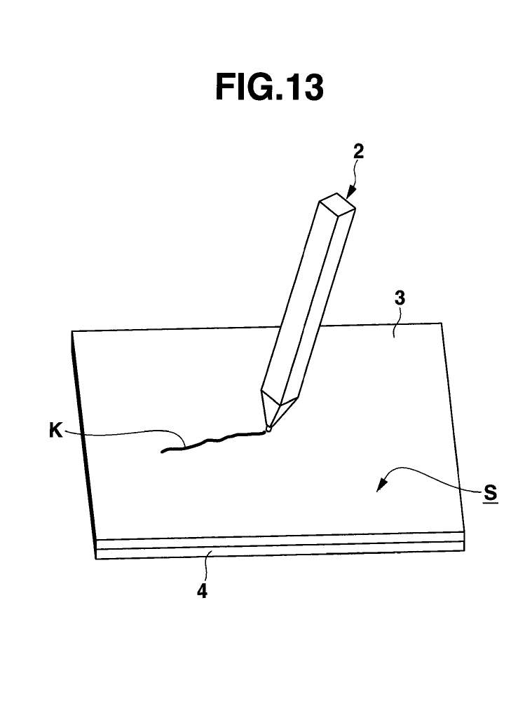

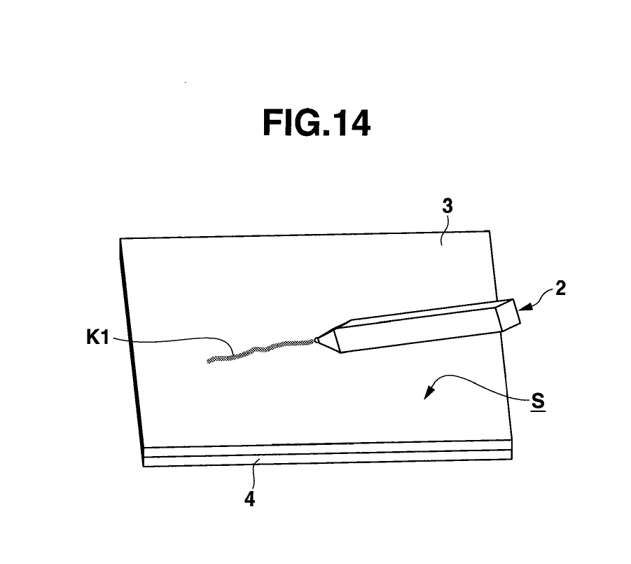

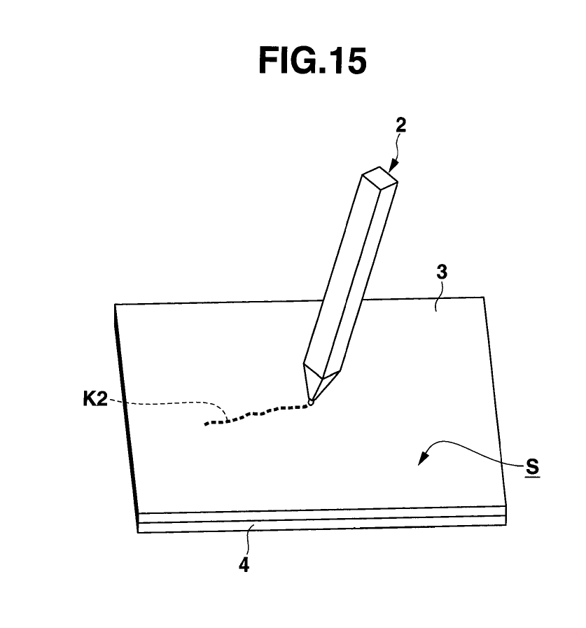

For example, FIG. 13 shows an example in which a drawing line K with no drawing effect applied thereto is displayed on the display device 4. Furthermore, FIG. 14 shows an example in which a drawing line K1 with the line width changing effect, one of the drawing effects, applied thereto is displayed on the display device 4. Additionally, FIG. 15 shows an example in which a drawing line K2 with the line type changing effect, one of the drawing effects, applied thereto is displayed on the display device 4.

As described above, according to the present embodiment, the first sensor 222 detects the component of the force applied to the tip of the shaft member 221, which acts in the planar direction orthogonal to the direction of the axis L of the shaft member 221. The second sensor 223 detects the component of the above-described force which acts in the direction of the axis L. Thus, force A can be calculated from the first detection result from the first sensor 222 and the second detection result from the second sensor 223. This allows force A applied to the contacted device 3 by the contact device 2 to be accurately detected.

Furthermore, with the first detection result from the first sensor 222 and the second detection result from the second sensor 223, the angle θ between the shaft member 221 and the plane S on the contacted object can be calculated.

The first detection result from the first sensor 222 also enables the angle of rotation φ of the shaft member 221 to be determined.

Then, when a figure is drawn at the position corresponding to the second information transmitted by the contacted device 3, the drawing effect associated with the results of calculation of force A, the angle θ, and the angle of rotation φ is applied to the figure. Thus, a different drawing effect can be reflected in the contents of display provided by the display device 4, simply by changing the state of the contact device 2 during drawing.

The present invention is not limited to the above-described embodiment and may be modified as needed.

For example, the controller 26 of the contact device 2 illustrated in the above-described embodiment has all the functions of the first, second, and third calculation units. However, the controller 52 of the contact device 5 may function as at least one of the first, second, and third calculation units. Furthermore, in the above-described embodiment, the first information transmitted to the exterior by the controller 26 of the control device 2 does not include the first detection result from the first sensor 222 or the second detection result from the second sensor 223. However, the first information may include the first detection result and the second detection result. Specific modifications will be described below.

### <Modification 1>

If the controller 26 of the control device 2 has all the functions of the first, second, and third calculation units, the controller 26 of the control device 2 may transmit, in addition to all the calculation results from the first to third calculation units, the first detection result from the first sensor 222 and the second detection result from the second sensor 223 to the exterior as the first information. In this case, the controller 52 of the control device 5 may draw a figure with a drawing effect applied thereto based not only on all the calculation results from at least the first to third calculation units but also on the first and second detection results.

### <Modification 2>

If the controller 26 of the control device 2 has only the functions of the second and third calculation units, the controller 26 of the control device 2 may transmit, in addition to the two calculation results from the second and third calculation units, the first detection result from the first sensor 222 to the exterior as the first information. In this case, the controller 26 of the control device 2 may or may not transmit the second detection result from the second sensor 223 to the exterior as the first information. Furthermore, the controller 52 of the control device 5 has the function of the first calculation unit to calculate the angle of rotation φ of the shaft member 221. Moreover, the controller 52 of the control device 5 may draw a figure with a drawing effect applied thereto, on the display device 4 based not only on all the calculation results from at least the second and third calculation units but also on the first detection result. If the controller 52 of the control device 5 receives the second information from the controller 26 of the contact device 2, the controller 52 of the control device 5 may draw a figure with a drawing effect applied thereto, on the display device 4 based on the first or second detection result.

### <Modification 3>

If the controller 26 of the control device 2 lacks the function of one of the second and third calculation units, the controller 26 of the control device 2 may transmit, in addition to all the calculation results from the calculation unit of the controller 26 of the control device 2, the first detection result from the first sensor 222 and the second detection result from the second sensor 223, to the exterior as the first information. In this case, the controller 52 of the control device 5 may have at least the function of the above-described one of the calculation units. That is, if the controller 26 of the control device 2 further lacks the function of the first calculation unit, the controller 52 of the control device 5 needs to have the function of the first calculation unit. In this case, the controller 52 of the control device 5 may draw a figure with a drawing effect applied thereto, on the display device 4 based not only on the calculation result from the other of the second and third calculation units but also on the first and second detection results. If the controller 26 of the control device 2 has the function of the first calculation unit, the controller 52 of the control device 5 may draw a figure with a drawing effect applied thereto, on the display device 4 based not only on the calculation result from the above-described other calculation unit but also on the calculation result from the first calculation unit.

Furthermore, the contact device 2 illustrated in the above-described embodiment incorporates the four first sensors 222. However, at least three first sensors 222 may be provided.

Additionally, in the case illustrated in the above-described embodiments, the display contents involve a drawing effect varying depending on the calculation results (force A, angle θ, and angle of rotation φ). Manipulation of an application other than the one for drawing may be assigned to the calculation results. This enhances the versatility of the contact device 2.

In addition, in the above-described embodiments, the angle of rotation φ is divided into four areas according to the magnitude of the angle so that each of the areas corresponds to one of the four side surfaces of the contact device 2. However, the angle of rotation φ may be divided into at most three or at least five areas according to the magnitude of the angle so that a function to apply any effect can be assigned to each area. That is, the number of segments into which the angle of rotation φ is divided may not be equal to that of the side surfaces of the contact device. Thus, the grip portion 211 may be, for example, cylindrical.

Furthermore, in the above-described embodiments, in step S11, the processing shifts to step S13 if the contact device 2 fails to transmit the first information. However, the processing may shift to step S13 if the value included in the first information is equal to or smaller than a predetermined value.

Additionally, in the above-described embodiments, the controller 52 of the control device 5 draws a figure with a drawing effect applied thereto, on the display device 4 based on all of the first to third calculation results (force A, angle θ, and angle of rotation φ). However, of course, the controller 52 of the control device 5 may draw a figure with a drawing effect applied thereto, on the display device 4 based exclusively on one or two of the first to third calculation results.

Several embodiments of the present invention have been described. However, the technical scope of the present invention includes the invention set forth in the claims and equivalents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An input apparatus comprising:
a contact device that includes:
a shaft member;
a first sensor configured to detect, when a tip of the shaft member comes into contact with a surface of a contacted object, a first force corresponding to a component of a force applied to the tip, which acts in a planar direction crossing a direction of an axis of the shaft at right angles; and
a second sensor configured to detect a second force corresponding to a component of the applied force, which acts in a direction of the axis of the shaft member.

2. The input apparatus according to claim 1, wherein the first sensor of the contact device comprises three planar-direction sensors configured to detect a rotating torque exerted on the shaft member, and
the three planar-direction sensors are arranged so as to contact three areas of side surfaces of the shaft member.

3. The input apparatus according to claim 1, wherein the second sensor of the contact device comprises an axial-direction sensor configured to detect a component of a force applied to the shaft member, which acts in the direction of the axis of the shaft member, and
the axial-direction sensor is arranged so as to contact a proximal end of the shaft member.

4. The input apparatus according to claim 1, further comprising a first calculation unit configured to calculate an angle of rotation by which the shaft member rotates around the axis of the shaft member based on a first detection result from the first sensor of the contact device.

5. The input apparatus according to claim 4, wherein when a point O is defined as an intersection point between the axis of the shaft member and a plane crossing the axis of the shaft member at right angles, and a point P is defined as a specific point on a periphery of a cross-sectional shape of the shaft member taken along a plane passing through the point O and crossing the axis at right angles, the angle of rotation of the shaft member is calculated to be a magnitude of an angle between a segment OP and a half line having the point O as a starting point and extending in a direction of a rotating torque exerted on the shaft member when the tip of the shaft member comes into contact with the surface of the contacted object.

6. The input apparatus according to claim 1, further comprising a second calculation unit configured to calculate a magnitude of a force applied to the surface of the contacted object by the tip of the shaft member, based on a first detection result from the first sensor of the contact device and a second detection result from the second sensor of the contact device.

7. The input apparatus according to claim 1, further comprising a third calculation unit configured to calculate an angle between the shaft member and a plane passing through a contact point between the shaft member and the surface of the contacted object and contacting the surface of the contacted object, based on a first detection result from the first sensor of the contact device and a second detection result from the second sensor of the contact device.

8. The input apparatus according to claim 1, wherein the contact device further comprises an information transmission unit configured to transmit, to an exterior, first information including a first detection result from the first sensor of the contact device and a second detection result from the second sensor of the contact device.

9. The input apparatus according to claim 1, further comprising:
a first calculation unit configured to calculate an angle of rotation by which the shaft member rotates around the axis of the shaft member, based on a first detection result from the first sensor of the contact device;
a second calculation unit configured to calculate a magnitude of a force applied to the surface of the contacted object by the tip of the shaft member, based on a first detection result from the first sensor of the contact device and a second detection result from the second sensor of the contact device; and
a third calculation unit configured to calculate an angle between the shaft member and a plane passing through a contact point between the shaft member and the surface of the contacted object and contacting the surface of the contacted object, based on the first detection result from the first sensor of the contact device and the second detection result from the second sensor of the contact device.

10. The input apparatus according to claim 9, wherein the contact device further comprises an information transmission unit configured to transmit, to an exterior, first information including one or both of the first detection result from the first sensor of the contact device and the second detection result from the second sensor of the contact device.

11. The input apparatus according to claim 9, further comprising a drawing effect applying unit configured to apply, to a figure, a drawing effect based on a result of a calculation carried out by any one of the first, second, and third calculation units, to draw the figure on a display screen of a display device.

12. The input apparatus according to claim 10, wherein any one of the first, second, and third calculation units is provided in the contact device, and
the information transmission unit of the contact device transmits a result of a calculation carried out by the one of the first, second, and third calculation units, to an exterior.

13. The input apparatus according to claim 12, further comprising a drawing effect applying unit configured to apply, to a figure, a drawing effect based on a result of a calculation carried out by the one of the first, second, and third calculation unit, to draw the figure on a display screen of a display device.

14. The input apparatus according to claim 9, further comprising a contacted device including the contacted object and transmitting, to an exterior, a signal corresponding to a contact position on the surface of the contacted object where the tip of the shaft member contacts the surface.

15. The input apparatus according to claim 11, further comprising a contacted device including the contacted object and transmitting, to an exterior, a signal corresponding to a contact position on the surface of the contacted object where the tip of the shaft member contacts the surface,
wherein the drawing effect applying unit applies the drawing effect based on the result of the calculation carried out by the one of the first, second, and third calculation units, to the figure to draw the figure on the display screen of the display device at a position corresponding to a signal corresponding to the contact position.

16. The input apparatus according to claim 13, further comprising a contacted device including the contacted object and transmitting, to an exterior, a signal corresponding to a contact position on the surface of the contacted object where the tip of the shaft member contacts the surface,
wherein the drawing effect applying unit applies the drawing effect based on the result of the calculation carried out by the one of the first, second, and third calculation units, to the figure to draw the figure on the display screen of the display device at a position corresponding to a signal corresponding to the contact position.

17. A contact state detection method comprising:
detecting, when a tip of the shaft member comes into contact with a surface of a contacted object, a first force corresponding to a component of a force applied to the tip, which acts in a planar direction crossing a direction of an axis of the shaft at right angles; and
calculating an angle of rotation by which the shaft member rotates around the axis of the shaft member, based on a result of the detection.

18. A contact state detection method comprising:
detecting, when a tip of the shaft member comes into contact with a surface of a contacted object, a first force corresponding to a component of a force applied to the tip, which acts in a planar direction crossing a direction of an axis of the shaft at right angles, and detecting a second force corresponding to a component of the applied force, which acts in a direction of the axis of the shaft member; and
calculating a magnitude of the force applied to the surface of the contacted object by the tip of the shaft member, based on results of the detections.

19. A contact state detection method comprising:
detecting, when a tip of the shaft member comes into contact with a surface of a contacted object, a first force corresponding to a component of a force applied to the tip, which acts in a planar direction crossing a direction of an axis of the shaft at right angles, and detecting a second force corresponding to a component of the applied force, which acts in a direction of the axis of the shaft member; and
calculating an angle between the shaft member and a plane passing through a contact point between the shaft member and the surface of the contacted object and contacting the surface of the contacted object, based on results of the detections.
